(19) United States
(12) Patent Application Publication
(10) Pub. No.: US 2016/0286955 A1
(43) Pub. Date: Oct. 6, 2016

(54) Collapsible Serving Cart with Wheels

(71) Applicant: Warren Cohen, Philadelphia, PA (US)

(72) Inventor: Warren Cohen, Philadelphia, PA (US)

(73) Assignee: Rio Brands, LLC

(21) Appl. No.: 14/678,915

(22) Filed: Apr. 3, 2015

(51) Int. Cl. A47B 31/04; B62B 5/06; B62B 3/02

(52) U.S. Cl. CPC A47B 31/04; B62B 3/02; B62B 5/06

(57) ABSTRACT

A collapsible service cart that has four legs that are configured into two scissor arrangements. The scissor arrangements are joined together by a handle, a cross bar and two axles. The cross bar and first axle extend through both the first leg and the second leg. The second axle extends through both the third leg and the fourth leg. Both axles support wheels. A first platform is provided that is pivotably connected to both the third leg and the fourth leg. The first platform has a catch that can selectively receive and engage the cross bar. A second platform is provided that is pivotably connected to the first axle. Slides are attached to the second platform with pivot joints. The slides run along the first leg and the second leg as the service cart is changed between its open configuration and collapsed configuration.

### BACKGROUND OF THE INVENTION

1. Field of the Invention

In general, the present invention relates to portable serving carts and tray tables that are foldable using scissor support legs. More particularly, the present invention relates to collapsible serving carts and tray tables that support two parallel tray platforms at different heights.

2. Prior Art Description

Serving carts are typically wheeled carts that are used to support and transport food or other items. Typically, a serving cart will have two parallel support platforms. An upper platform is supported at the top of the serving cart. The upper platform is readily accessible by a person standing next to the serving cart. A lower platform is positioned between one and two feet below the upper platform. The lower platform is typically used to hold supplies or materials that are less in demand than those held on the upper platform.

Many versions of the service cart exist. However, the present invention is primarily directed toward service trays that are lightweight, portable and collapsible. In the prior art, service carts with these features are commonly made with X-shaped side frames, often called scissor frames. These scissor frames enable the upper support surface and the lower support surface to fold flush against each other. Examples of such prior art designs include U.S. Pat. No. 3,215,096 to Holtz, entitled Collapsible Serving Cart. This patent shows a serving cart with two support surfaces and a scissor frame support. Both the upper platform and the lower platform are permanently attached to only two of the four legs. The other legs are only engaged by the platforms when the service cart is fully opened. Even at such times, the platforms merely engage the non-attached legs with insubstantial snap connections or similar mechanical engagements.

U.S. Pat. No. 3,602,160 to Heal, entitled Folding Trolleys and the Like, also shows a serving cart with two support platforms and an X-shaped framework. Both the upper support surface and the lower support surface are permanently attached to only two of the four legs. The support platforms snap connect to the secondary legs only when the serving cart is fully unfolded. This same configuration is also shown in U.S. Pat. No. 2,544,220 to Concklin; U.S. Pat. No. 2,196,914 to Goldman; and U.S. Pat. No. 3,099,356 to Burnett.

The common prior art design of permanently attaching the supported platform to only two of the four legs is used to allow the service trays to collapse. However, this configuration does have certain inherent disadvantages. Permanently attaching the platforms to only two of the four legs, tends to make the service cart wobbly. Since the attachment with the second leg is typically a snap connection, there is little rigidity between the second leg, the fourth leg, and the platforms. Forces are, therefore, not effectively exchanged between the legs and the service cart tends to be weaker than would be expected from its component parts.

A second disadvantage of the traditional service cart design is that a user must bend down and attach the lower service tray to the second leg once the service cart is fully unfolded. This action is difficult in confined areas where a service cart is often used. Furthermore, such actions are difficult for the elderly and frail who may want to use a service cart to help transport food or other materials from one point to another.

A need therefore exists for an improved collapsible service tray design where the lower platform is permanently affixed to all four support legs, yet the service cart is lightweight, portable and collapsible. A need also exists for a lightweight collapsible service cart that has improved strength and can hold more weight with more stability than prior art carts of the same size. These needs are met by the present invention as described and claimed below.

### SUMMARY OF THE INVENTION

The present invention is a collapsible service cart, cart. The service cart can be configured in an open operational configuration for use, or a collapsed configuration for storage. The collapsible service cart has four legs, which include a first leg, a second leg, a third leg and a fourth leg. The first leg and the third leg are joined at a first pivot connection in a first scissor arrangement. Likewise, the second leg and the fourth leg are joined together at a second pivot connection in a second scissor arrangement.

The first and second scissor arrangement are joined together by a handle, a cross bar and two axles. The cross bar extends from the first leg to the second leg. The first axle extends through both the first leg and the second leg. The second axle extends through both the third leg and the fourth leg. A first set of wheels is coupled to the first axle. A second set of wheels is coupled to the second axle. Both sets of wheels support the collapsible cart assembly.

A first platform is provided that is pivotably connected to both the third leg and the fourth leg. The first platform has a catch that can selectively receive and engage the cross bar.

A second platform is provided that is pivotably connected to the first axle. Slides are attached to the second platform with pivot joints. The slides run along the first leg and the second leg as the service cart is changed between its open configuration and collapsed configuration. However, the slides remain attached to the first and second legs in both configurations.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of a collapsible serving cart;

FIG. 2 is an exploded view of the exemplary embodiment of FIG. 1;

FIG. 3 is a cross-sectional view of the exemplary embodiment of FIG. 1, viewed along section line 3-3;

FIG. 4 shows the cross-sectional embodiment of

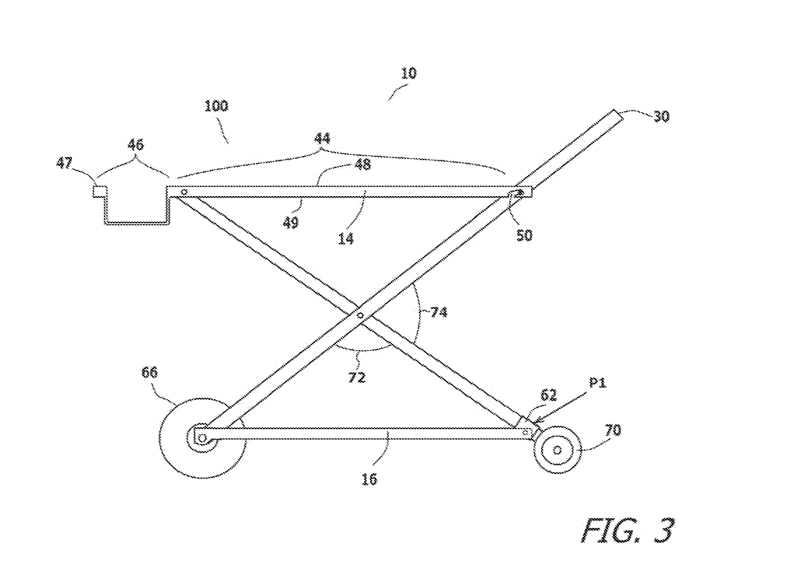

FIG. 3 in a partially collapsed configuration; and

FIG. 5 shows the cross-sectional embodiment of

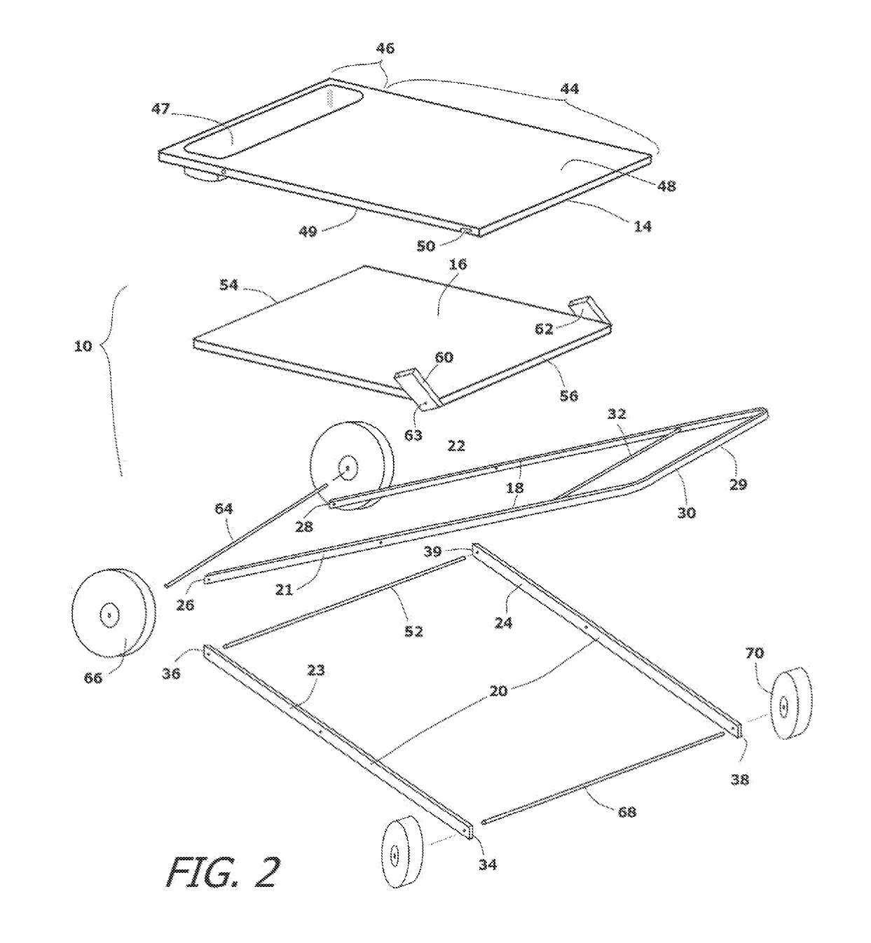

FIG. 2 in a fully collapsed configuration.

### DETAILED DESCRIPTION OF THE DRAWINGS

Although the present invention collapsible service cart can be configured into many different styles, only one exemplary embodiment is being illustrated. The embodiment illustrated shows a simple version of the collapsible service cart that is useful for description and discussion. The embodiment is selected only for the purposes of explanation, and should not be considered a limitation when interpreting the scope of the claims when filed.

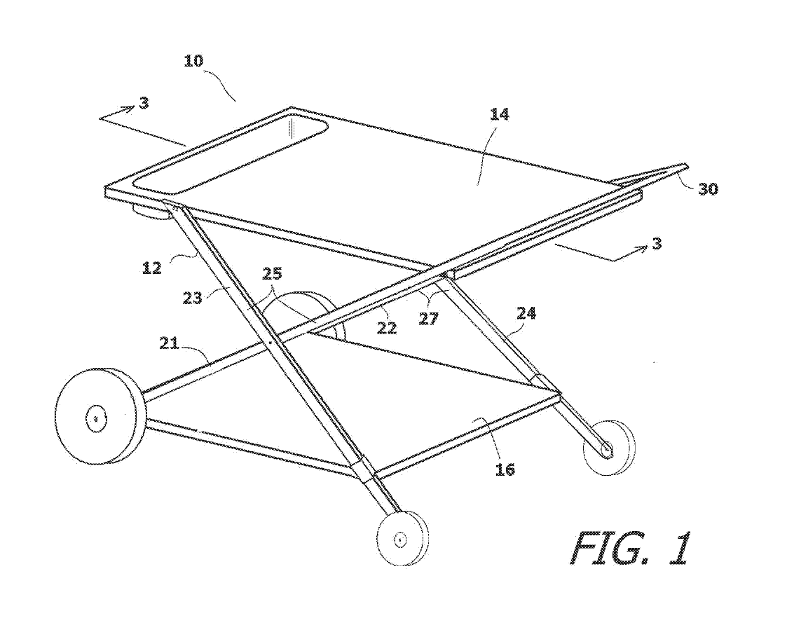

Referring to FIG. 1 in conjunction with FIG. 2 and FIG. 3, a service cart 10 is shown. The service cart 10 has a framework 12 that supports two platforms 14, 16. The framework 12 has four legs 21, 22, 23, 24 that are configured into two leg sets 18, 20. The first leg set 18 includes the first leg 21 and the second leg 22. Both the first leg 21 and the second leg 22 have free ends 26, 28, at the bottom of the legs 21, 22. In the shown embodiment, the first leg 21 and the second leg 22 are joined together by a U-shaped bend 29. The U-shaped bend 29 forms the handle 30 of the service cart 10. However, it should be understood that the first leg 21 and the second leg 22 could be separate elements that are joined together by a separately manufactured handle.

A cross bar 32 extends between the first leg 21 and the second leg 22 a short distance before the handle 30. The cross bar 32 is used to support the upper platform 14 when the service cart 10 is open. Furthermore, the cross bar 32 provides rigidity to the service cart 10 and works in unison with the handle 30 to maintain the first leg 21 and the second leg 22 in parallel orientations.

The second leg set 20 includes the third leg 23 and the fourth leg 24. The third leg 23 and the fourth leg 24 are separate elements. The third leg 23 has a first end 34 and an opposite second end 36. Likewise, the fourth leg 24 has a first end 38 and an opposite second end 39. The third leg 23 is connected to the first leg 21 at a first pivot joint 40. The first pivot joint 40 is located at or near the center of the third leg 23 between its first end 34 and second end 36. This creates a first scissor arrangement 25. Likewise, the fourth leg 24 is connected to the second leg 22 at a second pivot joint 42. The second pivot joint 42 is located at or near the center of the fourth leg 24 between its first end 38 and second end 39. This creates a second scissor arrangement 27.

The upper platform 14 has a flat section 44 and a tray section 46 that are unistructurally molded together. The flat section 44 has a flat top surface 48. The tray section 46 defines a tray 47 with an open top. The tray 47 has a significant depth, which makes the tray section 46 thicker than the remaining flat section 44. The flat section 44 has a bottom surface 49. A catch groove 50 is formed in the bottom surface 49.

A pivot rod 52 is provided. The pivot rod 52 extends from the first end 34 of the third leg 23 to the first end 38 of the fourth leg 38. The pivot rod 52 is rigid. As such, it provides rigidity to the second leg set 20 and helps maintain the parallel configuration between the third leg 23 and the fourth leg 24. The pivot rod 52 extends through the upper platform 14 at a point just before where the flat section 44 transitions into the tray section 46. The upper platform 14 is free to pivot about the pivot rod 52. However, the upper platform 14 cannot detach from the pivot rod 52.

The lower platform 16 is planar in shape. The lower platform 16 has a rear edge 54 that extends in the direction of the handle 30, and a forward edge 56 that extends in the opposite direction. Two slides 60, 62 are connected to the lower platform 16 near its rear edge 54. The slides 60, 62 are attached to the lower platform 16 with pivot joints 63. However, the slides 60, 62 cannot detach from the lower platform 16. The slides 60, 62 engage the second leg set 20, wherein the slides 60, 62 are free to move up and down the lengths of the third leg 23 and fourth leg 24.

A front axle rod 64 is provided. The front axle rod 64 extends between the free ends 26, 28 of the first leg 21 and the second leg 22. The front axle rod 64 extends through the lower platform 16 near the forward edge 56 of the lower platform 16. The lower platform 16 is free to rotate about the front axle rod 64 while remaining attached to the front axle rod 64. The front axle rod 64 is overlong and extends beyond the free ends 26, 28 of the first leg set 18. Large diameter wheels 66 are attached to the front axle rod 64.

A rear axle rod 68 extends between the second end 36 of the third leg 23 and the second end 39 of the fourth leg 24 in the second leg set 20. The rear axle rod 68 is rigid and reinforces the position and orientation of both the third leg 23 and the fourth leg 24. The rear axle rod 68 is overlong and extends beyond the second ends 36, 39 of the second leg set 20. Small diameter wheels 70 are attached to the rear axle rod 68.

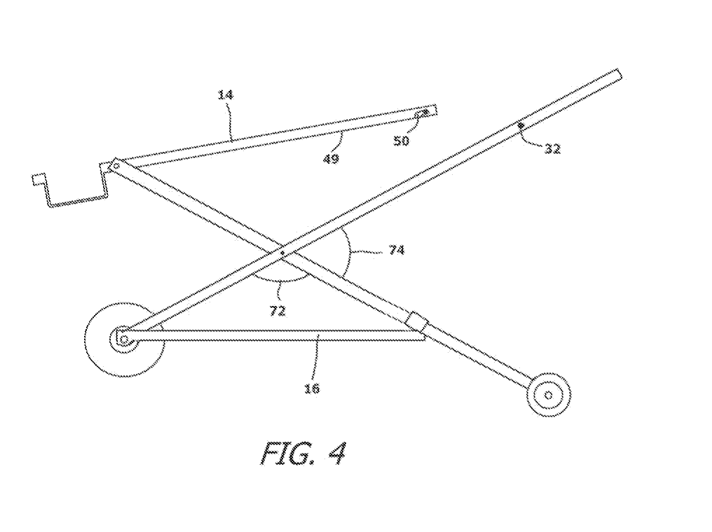

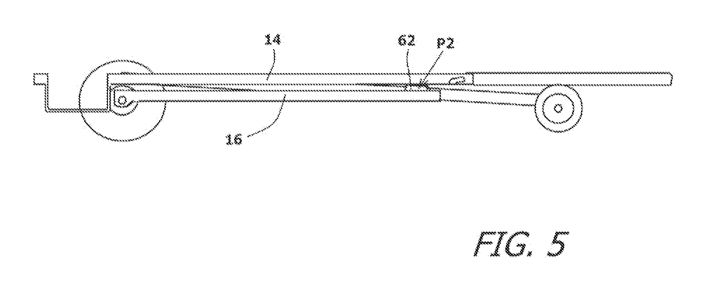

Referring to FIG. 4 and FIG. 5 in conjunction with FIG. 1, FIG. 2 and FIG. 3, it will be understood that the service cart 10 is collapsible. A fully open configuration 100 is shown in FIG. 1 and FIG. 3. A fully folded configuration 110 is shown in FIG. 4. In the fully open configuration 100, it can be seen that the upper platform 14 is elevated above the lower platform 16 by several inches. The catch groove 50 on the bottom surface 49 of the upper platform 14 is engaged with the cross bar 32 that extends between the first leg 21 and second leg 22. In the open configuration, the bottom angle 72 in each of the scissor arrangements 25, 27 is at its minimum, while the side angle 74 between the each of the scissor arrangements 25, 27 is at its maximum. Furthermore, the slides 60, 62 are at a first point P1 on the second leg set 20.

In the open configuration 100, the service cart 10 is both strong and stable. The service cart 10 can be lifted, pushed and/or pulled by the handle 30 without compromising the interconnection between the upper platform 14 and the cross bar 32. In this manner, the service cart 10 can be manipulated without concerns of accidentally collapsing the service cart 10.

In FIG. 4 and FIG. 5, it can be seen that in order to collapse the service cart 10, a person must first lift and manipulate the upper platform 14 in order to disengage the catch groove 50 from the cross bar 32. Once disengaged, gravity will bias the service cart 10 into its collapsed configuration 110. In the collapsed configuration 110, the bottom angle 72 of the scissor arrangements 25, 27 is at its maximum, while the side angle 74 of the scissor arrangements is at its minimum. Furthermore, the slides 60, 62 move to a lower second point P2 on the second leg set 20.

Referring to FIG. 5 in conjunction with FIG. 2, it can be seen that when the service cart 10 is in its collapsed condition, it is very thin. All four legs 21, 22, 23, 24 are near parallel. Furthermore, the lower platform 16 folds into close parallel proximity with the flat section 44 of the upper platform 14. The tray section 46 of the upper platform 14 overhangs the rear edge 54 of the lower platform 16. The overhang enables the lower platform 16 to lay close to the bottom surface 49 of the upper platform 14 without the tray section 46 getting in the way.

In the collapsed configuration, large diameter wheels 66 are the forward most element of the service cart 10. In this manner, the service cart 10 can be lifted by the handle 30 while in the collapsed configuration 110 and can still roll on the large diameter wheels 66. When the service cart 10 is laid flat in its collapsed configuration, it still is supported by both the large diameter wheels 66 and the small diameter wheels 70. The service cart 10 can therefore be rolled under a couch, bed or other confined space for storage.

It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. A collapsible cart, comprising:
a first leg;
a second leg;
a third leg;
a fourth leg;
wherein said first leg and said third leg are joined at a first pivot connection in a first scissor arrangement, and wherein said second leg and said fourth leg are joined at a second pivot connection in a second scissor arrangement;
a cross bar that extends from said first leg to said second leg;
a first axle that extends through both said first leg and said second leg;
a second axle that extends through both said third leg and said fourth leg;
a first set of wheels coupled to said first axle;
a second set of wheels coupled to said second axle;
a first platform that is pivotably connected to both said third leg and said fourth leg, said first platform having a catch that can selectively receive and engage said cross bar;
a second platform that is pivotably connected to said first axle; and
slides that run along said first leg and said second leg, wherein said slides are attached to said second platform.

2. The collapsible cart according to claim 1, wherein said slides are attached to said second platform with pivot joints.

3. The collapsible cart according to claim 1, further including a handle for pushing and pulling said collapsible cart.

4. The collapsible cart according to claim 2, wherein said handle is disposed between said first leg and said second leg.

5. The collapsible cart according to claim 4, wherein said handle is integrally formed as part of both said first leg and said second leg, wherein said handle is formed by bends in said first leg and said second leg.

6. The cart according to claim 1, wherein said first platform has a flat section and a tray section, wherein said tray section is thicker than said flat section.

7. The cart according to claim 6, wherein said third leg and said fourth leg are pivotably connected to said first platform at points between said tray section and said flat section.

8. The collapsible cart according to claim 1, wherein said collapsible cart can be selectively configured in an open configuration and a collapsed configuration.

9. The collapsible cart according to claim 8, wherein said catch on said first platform is engaged with said cross bar when said collapsible cart is in said open configuration.

10. The collapsible cart according to claim 8, wherein said second platform abuts against said first platform when said collapsible cart is in said closed configuration.

11. A collapsible cart, comprising:
a first set of legs joined at a first pivot connection in a first scissor arrangement;
a second set of legs joined at a second pivot connection in a second scissor arrangement;
a cross bar that extends from said first scissor arrangement to said second scissor arrangement, therein rigidly interconnecting said first scissor arrangement and said second scissor arrangement;
an axle that extends between said first scissor arrangement and said second scissor arrangement;
wheels that rotate on said axle;
a first platform that is pivotably connected to both said first scissor arrangement and said second scissor arrangement, said first platform having a catch that can selectively receive and engage said cross bar;
a second platform being pivotably connected to said axle; and
slides connected to said second platform that engage said first scissor arrangement and said second scissor arrangement.

12. The collapsible cart according to claim 11, wherein said collapsible cart can be selectively configured in an open configuration and a collapsed configuration.

13. The collapsible cart according to claim 12, wherein said catch on said first platform is engaged with said cross bar when said collapsible cart is in said open configuration.

14. The collapsible cart according to claim 12, wherein said second platform abuts against said first platform when said collapsible cart is in said closed configuration.

15. The collapsible cart according to claim 12, wherein said slides move along said first scissor arrangement and said second scissor arrangement as said collapsible cart moves between said open configuration and said closed configuration.

16. The collapsible cart according to claim 12, wherein said slides are attached to said second platform with pivot joints.

17. The collapsible cart according to claim 11, further including a handle for pushing and pulling said collapsible cart.

18. The collapsible cart according to claim 17, wherein said handle is disposed between said first scissor arrangement and said second scissor arrangement.
